(19) United States
(12) Patent Application Publication
(10) Pub. No.: US 2023/0065278 A1
(43) Pub. Date: Mar. 2, 2023

(54) METHOD FOR PRODUCING AN ETHER ESTEROL

(71) Applicant: Covestro Deutschland AG, Leverkusen (DE)

(72) Inventors: Martin Machat, Köln (DE); Aurel Wolf, Wülfrath (DE); Christoph Guertler, Köln (DE); Jakob Marbach, Leverkusen (DE)

(21) Appl. No.: 17/795,084

(22) PCT Filed: Mar. 19, 2021
(86) PCT No.: PCT/EP2021/057066

§ 371 Date: Jul. 25, 2022

(30) Foreign Application Priority Data
Mar. 25, 2020 (EP) 20165733.5

(51) Int. Cl. C08G 63/42; C08G 63/87; C08G 65/26

(52) U.S. Cl. CPC C08G 63/42; C08G 63/87; C08G 65/2663; C08G 65/2672; C08G 2650/58

(57) ABSTRACT

A method for producing an ether esterol, preferably a polyether esterol, is provided. The method comprises reacting an H-functional starter substance (1) with a cyclic anhydride (2) in the presence of a catalyst (4), wherein the cyclic anhydride (2) contains a specific alkylsuccinic acid anhydride (2-1) and the catalyst (4) is an amine, a double metal cyanide (DMC) catalyst and/or a Bronsted acid. Ether esterols, preferably polyether esterols obtainable using the claimed method are also provided..

### CROSS REFERENCE TO RELATED APPLICATIONS

This application is a U.S. national stage application, filed under 35 U.S.C. § 371, of International Application No. PCT/EP2021/057066, which was filed on Mar. 19, 2021, which claims priority to European Patent Application No. 20165733.5, which was filed on Mar. 25, 2020. The contents of each are hereby incorporated by reference into this specification.

### FIELD

The invention provides a process for preparing an etheresterol, preferably a polyetheresterol, by reaction of an H-functional starter substance (1) with a cyclic anhydride (2) in the presence of a catalyst (4), wherein the cyclic anhydride (2) contains a specific alkylsuccinic anhydride (2-1) and wherein the catalyst (4) is an amine, a double metal cyanide (DMC) catalyst and/or a Bronsted acid. The invention further provides etheresterols, preferably polyetheresterols, obtainable by the process of the invention.

### BACKGROUND

EP 0 687 698 A2 discloses liquid polyesters that are obtained by reaction of a cyclic anhydride with an epoxy compound in a molar ratio of 10:8 to 10:12, wherein the obtaining polyesters are used for film-forming materials.

DE 19 00 183 A1 discloses a process for preparing saturated polyesters by reacting a dicarboxylic anhydride and a polyhydric alcohol with an alkylene oxide in the presence of a Lewis-acidic catalyst.

US 4 430 131 A discloses ε-caprolactone-containing copolyester diols for production of polyurethane binders, by preparation by way of example of epoxides such as phenyl glycidyl ether, 1,2-epoxycyclohexane or allyl glycidyl ether with a dicarboxylic anhydride such as cis-1,2-cyclohexanedicarboxylic anhydride, methylsuccinic anhydride, 3-methylglutaric anhydride, pyrotartaric anhydride or phthalic anhydride with ε-caprolactone at 140-180° C. in the presence of dibutyltin laurate or lead 2-ethylhexanoate catalysts and ethylene glycol as cocatalyst.

WO 2012/126921 A1 discloses polyesters having repeat units based on at least one aliphatic dicarboxylic acid or an ester-forming derivative thereof as component A1, at least one aromatic dicarboxylic acid or an ester-forming derivative thereof, at least one diol, wherein component A1 contains 2-methylsuccinic acid or an ester-forming derivative thereof. The corresponding polyester is prepared by a polycondensation reaction, wherein the water that forms has to be removed.

### SUMMARY

It was an object of the present application to provide an efficient and easily scaled-up process for preparing etheresterols, preferably polyetheresterols, having improved process control, in which the product can be provided in a minimum number of preparation steps. In addition, the viscosity of the resulting etheresterol, preferably polyetheresterol, products is to be reduced compared to prior art systems for a defined composition and a given OH number (hydroxyl number), or crystallization of the etheresterols is even to be avoided. The intention is thus to enable use of these products as monool or polyol component directly or at least in a simplified manner in the downstream polyurethane (PU) production, preferably rigid PU foam production. The resulting rigid PU foams are to have equivalent or improved physical properties, such as foam indices or flame retardancy properties, compared to prior art formulations. Furthermore, the conversion of the reactants used is also to be improved, for example increasing the conversion of alkylene oxide in order to reduce the complex removal, purification and reuse or disposal of these starting materials, some of which are toxic.

It has been found that, surprisingly, the object of the invention is achieved by a process for preparing an etheresterol, preferably a polyetheresterol, by reaction of an H-functional starter substance (1) with a cyclic anhydride (2) in the presence of a catalyst (4);

wherein the cyclic anhydride (2) contains alkylsuccinic anhydride (2-1) of the following formula (I):

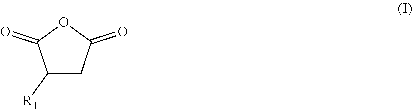

where R₁ is methyl, ethyl, n-propyl, isopropyl, n-butyl, isobutyl, n-pentyl, isopentyl, n-hexyl, isohexyl, n-heptyl, isoheptyl, n-octyl, isooctyl, n-nonyl, isononyl, n-decyl, isodecyl, n-dodecyl, isododecyl or cyclohexyl, preferably methyl, ethyl, n-propyl, isopropyl, n-butyl, isobutyl, n-hexyl or isohexyl and more preferably methyl, and wherein the catalyst (4) is an amine, a double metal cyanide (DMC) catalyst and/or a Bronsted acid.

### DETAILED DESCRIPTION

Etheresterols of the invention are understood to mean compounds having one or more ether functionalities (ether groups), one or more ester functionalities (ester groups), and one or more hydroxyl functionalities (monools or polyols). The ether functionalities result here from ring opening of the alkylene oxide (3) and addition at least of two or more alkylene oxides onto an H-functional starter substance (1). The ester functionalities are formed, for example, by ring opening of the cyclic anhydride (2) and reaction with a compound containing hydroxyl groups, such as H-functional starter substance (1) having terminal hydroxyl groups. The hydroxyl functionalities (monools or polyols) result from the ring opening of the alkylene oxide (3) and addition onto H-functional starter substance (1) and/or onto monoesters formed by ring opening of the cyclic anhydrides (2). According to the invention, the number of respective ether, ester and hydroxyl functionalities, primarily of ether and ester functionalities, depends on the molar ratio of H-functional starter substance (1), of the cyclic anhydride (2) and of the alkylene oxide (3) used. In addition, the hydroxyl functionality (mono- or polyol) is highly dependent on the functionality of the H-functional starter substance (1) used. In addition, it is also possible to form additional imide functionalities or amide functionalities when an NH-functional starter substance (1-3) or an NH₂-functional starter substance (1-2) is used.

According to the invention, a polyetheresterol has one or more ether functionalities, preferably multiple ether functionalities, one or more ester functionalities, preferably multiple ester functionalities, and one or more hydroxyl functionalities, preferably multiple hydroxyl functionalities, that may be distributed randomly and/or in blocks over the polyetheresterol.

In one embodiment of the process of the invention, the H-functional starter substance (1) is an OH-functional starter substance (1-1), an NH₂-functional starter substance (1-2), an NH-functional starter substance (1-3) and/or a COOH-functional starter substance (1-4), preferably an OH-functional starter substance (1-1) and/or a COOH-functional starter substance (1-4), and more preferably an OH-functional starter substance (1-1).

An OH-functional starter substance (1-1) is understood here to mean a compound having at least one free hydroxyl group, an NH₂-functional starter substance (1-2) to mean one having at least one primary amine group, an NH-functional starter substance (1-3) to mean one having at least one secondary amine group, and/or a COOH-functional starter substance (1-4) to mean one having at least one free carboxyl group.

H-functional starter substances selected may, for example, be one or more compounds selected from the group comprising water or monohydric or polyhydric alcohols, monobasic or polybasic carboxylic acids, hydroxycarboxylic acids, hydroxy esters, polyether polyols, polyester polyols, polyesterether polyols, polyethercarbonate polyols, poly etherestercarbonate polyols, polycarbonate polyols, polycarbonates, polytetrahydrofurans (e.g. PolyTHF® from BASF, such as PolyTHF® 250, 650S, 1000, 1000S, 1400, 1800, 2000), polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. Examples of C1-C23 alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®TM products (from USSC Co.).

Monofunctional starter substances used may be alcohols, thiols and carboxylic acids. Monofunctional alcohols that may be used include: methanol, ethanol, ethenol, 1-propanol, 2-propanol, 2-propenol, 1-butanol, 2-butanol, tert-butanol, 3-buten-l-ol, 3-butyn-l-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-dodecanol, Palmerol, 1-hexadecanol, phenol, 2-hydroxybiphenyl, 3-hydroxybiphenyl, 4-hydroxybiphenyl, 2-hydroxypyridine, 3-hydroxypyridine, 4-hydroxypyridine.

Suitable polyhydric alcohols as OH-functional starter substances (1-1) having at least two terminal hydroxyl groups are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these aforementioned alcohols having different amounts of ε-caprolactone.

Examples of NH₂-functional starter substances (1-2) include butylamine, tert-butylamine, pentylamine, hexylamine, aniline, aziridine, pyrrolidine, piperidine, morpholine, pentamethylenediamine (PDA), hexamethylenediamine (HDA), isophoronediamine (IPDA), toluenediamine (TDA) including the known regioisomers 2,4-TDA, 2,6-TDA, 2,3-TDA and 3,4-TDA, and diaminodiphenylmethane (MDA) including the known regioisomers 2,4′-MDA and 4,4′-MDA.

NH-functional starter substances (1-3) include derivatives of ammonia having alkyl and/or aryl substituents, for example dimethylamine, diethylamine, diisopropylamine, dibutylamine, di-tert-butylamine, dipentylamine, dihexylamine, diphenylamine. In addition, compounds having multiple NH functionalities are possible.

Suitable monobasic carboxylic acids as COOH-functional starter substance (1-4) having a free carboxyl group are methanoic acid, ethanoic acid, propanoic acid, butanoic acid, pentanoic acid, hexanoic acid, heptanoic acid, octanoic acid, lactic acid, stearic acid, palmitic acid, oleic acid, linoleic acid, linolenic acid, benzoic acid, acrylic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid and benzoic acid. In addition, it is possible to use mixtures of fatty acid/fatty alcohol, preferably C10-C18.

Suitable polybasic carboxylic acids as COOH-functional starter substance (1-4) having at least two carboxyl groups include oxalic acid, malonic acid, succinic acid, glutaric acid, adipic acid, pimelic acid, suberic acid, azelaic acid, sebacic acid, trimesic acid, fumaric acid, maleic acid, decane-1,10-dicarboxylic acid, dodecane-1,12-dicarboxylic acid, phthalic acid, isophthalic acid, terephthalic acid, pyromellitic acid and trimellitic acid.

Examples of hydroxycarboxylic acids monobasic carboxylic acids suitable as H-functional starter substances, as COOH-functional starter substance (1-4) having at least one free carboxyl group, include ricinoleic acid, glycolic acid, lactic acid, 3-hydroxypropionic acid, malic acid, citric acid, mandelic acid, tartronic acid, tartaric acid, mevalonic acid, 4-hydroxybutyric acid, salicylic acid, 4-hydroxybenzoic acid and isocitric acid.

The H-functional starter substances (1) may also be selected from the substance class of the polyether polyols, especially those having a molecular weight Mn in the range from 50 to 4000 g/mol. Preference is given to polyether polyols formed from repeat ethylene oxide and propylene oxide units, preferably comprising a proportion of 35% to 100% propylene oxide units, more preferably comprising a proportion of 50% to 100% propylene oxide units. These may be random copolymers, gradient copolymers, alternating copolymers or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex®, Baygal®, PET® and polyether polyols from Covestro AG (e.g. Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter substances (1) may also be selected from the substance class of the polyester polyols, especially those having a molecular weight Mn in the range from 50 to 4500 g/mol. Polyester polyols used may be at least difunctional polyesters. Polyester polyols preferably consist of alternating acid and alcohol units. Examples of usable acid components include succinic acid, succinic anhydride, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the stated acids and/or anhydrides. Examples of alcohol components used include ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol, or mixtures of the stated alcohols. The resulting polyester polyols have terminal hydroxyl and/or carboxyl groups.

In addition, H-functional starter substances (1) used may be polycarbonate diols, especially those having a molecular weight Mn in the range from 50 to 4500 g/mol which are prepared, for example, by reaction of phosgene, dimethyl carbonate, diethyl carbonate or diphenyl carbonate and difunctional alcohols or polyester polyols or polyether polyols. Examples for polycarbonates are found, for example, in EP-A 1359177. Polycarbonate diols that may be used include for example the Desmophen® C line from Covestro AG, for example Desmophen® C 1100 or Desmophen® C 2200.

In a further embodiment of the invention, it is possible to use polyethercarbonate polyols (for example cardyon® polyols from Covestro), polycarbonate polyols (for example Converge® polyols from Novomer/Saudi Aramco, NEOSPOL polyols from Repsol etc.) and/or polyetherestercarbonate polyols as H-functional starter compounds. Polyethercarbonate polyols, polycarbonate polyols and/or polyetherestercarbonate polyols may in particular be obtained by reaction of alkylene oxides, preferably ethylene oxide, propylene oxide or mixtures thereof, optionally further comonomers, with CO₂ in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO₂ is given for example by Chemical Communications 47 (2011) 141-163. The use of different catalyst systems, reaction conditions and/or reaction sequences results here in the formation of random, alternating, block-type or gradient-type polyethercarbonate polyols, polycarbonate polyols and/or polyetherestercarbonate polyols. To this end, these polyethercarbonate polyols, polycarbonate polyols and/or polyetherestercarbonate polyols used as H-functional starter compounds may be prepared in a separate reaction step beforehand.

The H-functional starter substances (1) generally have an OH functionality (i.e. the number of polymerization-active H atoms per molecule) of 1 to 8, preferably of 2 to 6 and more preferably of 2 to 4. The H-functional starter substances are used either individually or as a mixture of at least two H-functional starter substances.

Preferred H-functional starter substances are alcohols having a composition according to general formula (II)

HO-(CH₂)ₓ-OH (II)

where x is a number from 1 to 20, preferably an even number from 2 to 20. Examples of alcohols of formula (II) are ethylene glycol, butane-1,4-diol, hexane-1,6-diol, octane-1,8-diol, decane-1,10-diol and dodecane-1,12-diol. Further preferred H-functional starter substances are neopentyl glycol, trimethylolpropane, glycerol and pentaerythritol.

Preference is further given to using, as H-functional starter substances, water, diethylene glycol, dipropylene glycol, castor oil, sorbitol and polyether polyols formed from repeat polyalkylene oxide units.

The OH-functional starter substance (1-1) is more preferably one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have an OH functionality of 2 to 4 and a molecular weight Mn in the range from 62 to 4500 g/mol and in particular a molecular weight Mn in the range from 62 to 3000 g/mol.

In one embodiment of the process according to the invention, OH functionality is from 2 to 6 and a molecular weight is from 18 g/mol to 2000 g/mol, preferably from 2 to 4 and preferably from 60 g/mol to 1000 g/mol.

In one embodiment of the process of the invention, the H-functional starter substance is one or more compound(s) and is selected from the group consisting of water, ethylene glycol, diethylene glycol, polyethylene glycol, dipropylene glycol, polypropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid, salicylic acid and esters of the aforementioned alcohols and acids.

Cyclic anhydrides (2) in the process of the invention are cyclic compounds containing an anhydride group in the ring. Preferred compounds are succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and the chlorination products thereof, glutaric anhydride, diglycolic anhydride, 1,8-naphthalic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5 -dione, 3 -methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-l-yl)dihydrofuran-2,5-dione, N-(2,5-dioxotetrahydrofuran-3-yl)formamide and 3[(2E)-but-2-en-1-yl]dihydrofuran-2,5-dione. Particular preference is given to succinic anhydride, maleic anhydride and phthalic anhydride.

In the process of the invention, the cyclic anhydride (2) contains alkylsuccinic anhydride (2-1) of the following formula (I):

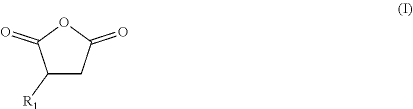

where R1 is methyl, ethyl, n-propyl, isopropyl, n-butyl, isobutyl, n-pentyl, isopentyl, n-hexyl, isohexyl, n-heptyl, isoheptyl, n-octyl, isooctyl, n-nonyl, isononyl, n-decyl, isodecyl, n-dodecyl, isododecyl or cyclohexyl, preferably methyl, ethyl, n-propyl, isopropyl, n-butyl, isobutyl, n-hexyl or isohexyl and more preferably methyl (methylsuccinic acid).

In one embodiment of the process of the invention, the molar proportion of the alkylsuccinic anhydride (2-1) is from 5 mol % to 100 mol %, preferably from 15 mol % to 100 mol % and more preferably from 25 mol % to 100 mol %, based on the sum total of all cyclic anhydrides (2) used.

In one embodiment of the process of the invention, the H-functional starter substance (1) is reacted with the cyclic anhydride (2) in the presence of the catalyst (4) and in the presence of an alkylene oxide (3).

Alkylene oxides (3) used in the process of the invention may be alkylene oxides having 2-45 carbon atoms. The alkylene oxides having 2-45 carbon atoms are, for example, one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, alkylene oxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether. Alkylene oxides used are preferably ethylene oxide and/or propylene oxide, more preferably ethylene oxide as alkylene oxide (3).

If ethylene oxide and propylene oxide are used in a mixture, the molar ratio of ethylene oxide to propylene oxide is from 1:99 to 99:1, preferably from 95:5 to 50:50.

In one embodiment of the process of the invention, the cyclic alkylene oxide (3) is added to the reactor continuously or stepwise.

In one embodiment of the process of the invention, the catalyst (4) is an amine

In the process of the invention, a double metal cyanide (DMC) catalyst is used as catalyst (4), where the usable DMC catalysts contain double metal cyanide compounds that are the reaction products of water-soluble metal salts and water-soluble metal cyanide salts.

Double metal cyanide (DMC) catalysts for use in the homopolymerization of alkylene oxides are known in principle from the prior art (see, for example, U.S. Pat. Nos. 3,404,109, 3,829,505, 3,941,849 and 5,158,922). DMC catalysts described, for example, in U.S. Pat. No. 5,470,813, EP-A 700 949, EP-A 743 093, EP-A 761 708, WO 97/40086, WO 98/16310 and WO 00/47649 have a very high activity and enable the preparation of polyoxyalkylene polyols at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts which can be used in accordance with the invention are preferably obtained by
(1.) in a first step, reacting an aqueous solution of a metal salt with the aqueous solution of a metal cyanide salt in the presence of one or more organic complex ligands, e.g. an ether or alcohol,
(2.) in a second step, using known techniques (such as centrifugation or filtration) to remove the solid from the suspension obtained from (1.),
(3.) optionally, in a third step, washing the isolated solid with an aqueous solution of an organic complex ligand (for example by resuspension and subsequent reisolation by filtration or centrifugation),
(4.) and subsequently drying the solid obtained at temperatures of in general 20-120° C. and at pressures of in general 0.1 mbar to atmospheric pressure (1013 mbar), optionally after pulverizing,
   wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts that can be used in accordance with the invention are the reaction products of water-soluble metal salts and water-soluble metal cyanide salts.

By way of example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the suspension formed.

Metal salts suitable for preparing the double metal cyanide compounds preferably have a composition according to the general formula (III),

M(X)ₙ (III),

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, carboxylate, cyanate, thiocyanate, isocyanate, isothiocyanate or nitrate,

or suitable metal salts preferably have a composition according to the general formula (IV)

Mᵣ(X)₃ (IV),

where

M is selected from the metal cations Fe³⁺, Al³⁺, Co³⁺ and Cr³⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, carboxylate, cyanate, thiocyanate, isocyanate, isothiocyanate or nitrate,

or suitable metal salts preferably have a composition according to the general formula (V)

M(X)ₛ (V),

where

M is selected from the metal cations Mo⁴⁺, V⁴⁺ and W⁴⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, carboxylate, cyanate, thiocyanate, isocyanate, isothiocyanate or nitrate,

or suitable metal salts preferably have a composition according to the general formula (VI)

M(X)ₜ (VI),

where

M is selected from the metal cations Mo⁶⁺ and W⁶⁺,

X comprises one or more (i.e. different) anions, preferably anions selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (VII)

(Y)ₐ M′(CN)_{b} (A)_{c} (VII),

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg₂₊, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, where the values for a, b and c are selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds included in the DMC catalysts which can be used in accordance with the invention are compounds having compositions according to the general formula (VIII)

Mₓ[M′ₓ,(CN)_{y}]_{z} (VIII)

in which M is as defined in the formulae (I) to (IV) and

M′ is as defined in formula (V), and

x, x′, y and z are integers and are chosen so as to give electron neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds (VI) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). With particular preference it is possible to use zinc hexacyanocobaltate(III).

The organic complex ligands which can be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which include both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol, for example). Extremely preferred organic complex ligands are selected from one or more compounds of the group consisting of dimethoxyethane, tert-butanol 2-methyl-3-buten-2-ol, 2-methyl-3-butyn-2-ol, ethylene glycol mono-tert-butyl ether and 3-methyl-3-oxetanemethanol.

In the preparation of the DMC catalysts which can be used in accordance with the invention, there is optional use of one or more complex-forming component(s) from the compound classes of the polyethers, polyesters, polycarbonates, polyalkylene glycol sorbitan esters, polyalkylene glycol glycidyl ethers, polyacrylamide, poly (acrylamide-co-acrylic acid), polyacrylic acid, poly(acrylic acid-co-maleic acid), polyacrylonitrile, polyalkylacrylates, polyalkylmethacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α,β-unsaturated carboxylic esters, or ionic surface-active or interface-active compounds.

In the preparation of the DMC catalysts which can be used in accordance with the invention, preference is given to using the aqueous solutions of the metal salt (e.g. zinc chloride) in the first step in a stoichiometric excess (at least 50 mol %) relative to the metal cyanide salt. This corresponds to at least a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

The organic complex ligand may be present here in the aqueous solution of the metal salt and/or the metal cyanide salt, or it is added directly to the suspension obtained after precipitation of the double metal cyanide compound. It has been found to be advantageous to mix the metal salt and the metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, particularly preferably using a jet disperser, as described, for example, in WO-A 01/39883.

In the second step, the solid (i.e. the precursor of the catalyst) can be isolated from the suspension by known techniques, such as centrifugation or filtration.

In a preferred variant, the isolated solid is then washed with an aqueous solution of the organic complex ligand (for example by resuspension and subsequent reisolation by filtration or centrifugation) in a third process step. In this way, for example, water-soluble by-products, such as potassium chloride, can be removed from the catalyst that can be used in accordance with the invention. The amount of the organic complex ligand in the aqueous wash solution is preferably between 40% and 80% by weight, based on the overall solution.

Optionally in the third step the aqueous wash solution is admixed with a further complex-forming component, preferably in the range between 0.5% and 5% by weight, based on the overall solution.

It is also advantageous to wash the isolated solid more than once. Preferably, in a first wash step (3.-1), an aqueous solution of the organic complex ligand is used for washing (for example by resuspension and subsequent reisolation by filtration or centrifugation), in order in this way to remove, for example, water-soluble by-products such as potassium chloride from the catalyst which can be used in accordance with the invention. It is particularly preferable when the amount of the organic complex ligand in the aqueous wash solution is between 40% and 80% by weight based on the overall solution for the first wash step. In the further wash steps (3.-2), either the first wash step is repeated once or more than once, preferably once to three times, or, preferably, a nonaqueous solution, for example a mixture or solution of organic complex ligands and further complex-forming component (preferably in the range between 0.5% and 5% by weight, based on the total amount of the wash solution in the step (3.-2)), is used as a wash solution to wash the solid once or more than once, preferably once to three times.

The isolated and optionally washed solid can then be dried, optionally after pulverization, at temperatures of 20-100° C. and at pressures of 0.1 mbar to atmospheric pressure (1013 mbar).

One preferred method for isolating the DMC catalysts which can be used in accordance with the invention from the suspension by filtration, filtercake washing and drying is described in WO-A 01/80994.

In the process of the invention, a Bronsted acid is additionally used as catalyst (4).

In line with the customary definition in the art, Bronsted acids are to be understood as meaning substances capable of transferring protons to a second reaction partner, the so-called Bronsted base. In the context of the present invention, the term “Bronsted-acidic catalyst” is to be understood as meaning a non-polymeric compound, wherein the Bronsted-acidic catalyst has a calculated molar mass of ≤1200 g/mol, preferably of ≤1000 g/mol and particularly preferably of ≤850 g/mol.

In the process according to the invention, the Bronsted acid has a pKa of 1 or less, preferably of less than or equal to zero.

The Bronsted acid is selected, for example, from one or more compound(s) from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, trichloroacetic acid, methanesulfonic acid, paratoluenesulfonic acid, aromatic sulfonic acids and aliphatic sulfonic acids.

In a preferred embodiment of the process according to the invention, the Bronsted acid is one or more compound(s) selected from the group consisting of trifluoromethanesulfonic acid, perchloric acid, hydrochloric acid, hydrobromic acid, hydroiodic acid, sulfuric acid, nitric acid, methanesulfonic acid, trichloroacetic acid and trifluoroacetic acid. The Bronsted acid used is more preferably trifluoromethanesulfonic acid.

In the process of the invention, an amine is additionally used as catalyst (4).

In a preferred embodiment of the process of the invention, a tertiary amine is used as catalyst (4).

Tertiary amines, in accordance with common art knowledge, are derivatives of ammonia having tertiary amine groups in which all 3 hydrogen atoms have been replaced by alkyl, cycloalkyl, aryl groups, where these alkyl, cycloalkyl, aryl groups may be identical or different, also combined to form mono- or polynuclear heterocyclic ring systems. In addition, the tertiary amines may also contain two or more tertiary amine groups. The tertiary amines of the invention may also contain further heteroatoms, for example oxygen.

In one embodiment of the process of the invention, the tertiary amine is one or more compound(s) and is selected from the group consisting of trimethylamine, triethylenediamine, triisopropylamine, tributylamine, tripentylamine, trihexylamine, triphenylamine, dimethylethylamine, N,N-dimethylcyclohexylamine, tetramethylenediamine, 1-methyl-4-dimethylaminoethylpiperazine, triethylamine, tripropylamine, tributylamine, dimethylbutylamine, N,N-dimethylbenzylamine, N,N-dimethylcyclohexylamine, N,N′,N″-tris-(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, bis(dimethylaminoethyl) ether, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, 1,8-diazabicyclo[5.4.0]undec-7-ene (DBU), 1,5,7-triazabicyclo[4.4.0]dec-5-ene (TBD), 1,4-diazabicyclo[2.2.2]octane (DABCO), imidazole, 1-methylimidazole, 2-methylimidazole, 4(5)-mathylimidazole, 2,4(5)-dimethylimidazole, 1-ethylimidazole, 2-ethylimidazole, 1-phenylimidazole, 2-phenylimidazole, 4(5)-phenylimidazole and N,N-dimethylaminopyridine, guanidine, 1,1,3,3-tetramethylguanidine, pyridine, 1-azanaphthalene (quinoline), N-methylpiperidine, N-methylmorpholine, N,N′-dimethylpiperazine and N,N-dimethylaniline.

In a preferred embodiment of the process of the invention, the amine catalyst is one or more compound(s) and is selected from the group consisting of benzyldimethylamine, N,N-dimethylcyclohexylamine, diazabicyclo[2.2.2]octane (DABCO), imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, and 4(5)-phenylimidazole.

In one embodiment of the process of the invention, the amine catalyst is used in an amount of 10-50 000 ppm (based on the total mass of the product), preferably 100-10 000 ppm.

According to the standard technical definition, a solvent is understood to mean one or more compounds that dissolve the H-functional starter compound (1), the cyclic anhydride (2), the alkylene oxide (3) and/or the catalyst (4), but without itself reacting with the H-functional starter compound (1), the cyclic anhydride (2), the alkylene oxide (3) and/or the catalyst (4).

In one embodiment, the process of the invention is performed without addition of a solvent, such that there is no need to remove this solvent in an additional process step after the preparation of the etheresterol, preferably the polyetheresterol.

In one embodiment, the process of the invention comprises the following steps:
i) reacting the H-functional starter substance (1) and the cyclic anhydride (2), optionally in the presence of the catalyst (4), to form a mixture (i),
ii) adding the portion of the alkylene oxide (3) to form the etheresterol, preferably the polyetheresterol.

In a preferred embodiment, the H-functional starter substance (1) is an OH-functional starter substance (1-1) having terminal hydroxyl groups, and the reaction with the cyclic anhydride (2) comprising the alkylsuccinic anhydride (2-1) of the invention in step (i) is effected in a polyaddition reaction. This polyaddition reaction is advantageous over the polycondensation reaction with di- or polycarboxylic acids, for example methylsuccinic acid, previously described in the prior art since there is no need to remove any coproduct, for example water. This removal results in additional time demands and apparatus complexity.

In a preferred embodiment of the process of the invention, the catalyst (4) is added in step (i).

In an alternative preferred embodiment of the of the invention, a portion (m4-1) of the catalyst (4) is added in step i) and a second portion of the catalyst (m4-2) at a juncture between step (i) and step (ii), which achieves a further reduction in the viscosity of the etheresterol, preferably of a polyetheresterol.

In one embodiment of the process of the invention, 50.1 mol % to 100 mol %, preferably 60 mol % to 100 mol %, of the portion (m4-2) of the catalyst, based on the sum total of the portion (m4-1) and portion (m4-2), is added.

The tertiary amine added here in portion (m4-1) may be identical to or different than the tertiary amine added as portion (m4-2). The amines added are preferably identical.

In an alternative, less preferred embodiment, the process of the invention comprises the reacting of the OH-functional starter substance (1-1) of the invention with the cyclic anhydride (2) of the invention, comprising the alkylsuccinic anhydride (2-1) of the invention, in the presence of the COOH-functional starter substance (1-4) of the invention, optionally in the presence of an esterification catalyst, preferably in the presence of an esterification catalyst. As a result of the presence of the COOH-functional starter substance (1-4) containing free carboxyl groups, the reaction with the OH-functional starter substance (1-1) proceeds in a polycondensation reaction, with the need to remove resultant water.

Any of the esterification catalysts known for the preparation of polyesters are useful here. Likewise, catalysts for catalyzing the esterification reaction can be added to the reaction mixture. Examples here include: tin(II) salts, such as for example tin dichloride, tin dichloride dihydrate, tin(II) 2-ethylhexanoate, dibutyltin dilaurate; titanium alkoxides, for example titanium tetrabutoxide, tetraisopropyl titanate; bismuth(III) neodecanoate; zinc(II) acetate; manganese(II) acetate or protic acids, for example p-toluenesulfonic acid. In addition, the esterifications may also be catalyzed by enzymes, for example esterases and/or lipases.

In one embodiment of the process of the invention, the molar ratio of the cyclic anhydride (2) to the starter functionality of the H-functional starter substance (1) is between 0.5:1 and 20:1, preferably between 0.5:1 and 10:1.

In one embodiment of the process of the invention, the H-functional starter substance (1) is an OH-functional starter substance (1-1) having terminal hydroxyl groups, and the molar ratio of the alkylene oxide (3) to the cyclic anhydride (2) is from 1.05:1 to 3.0:1, preferably from 1.1:1 to 2.0:1.

In an alternative embodiment of the process of the invention, the H-functional starter substance (1) is a COOH-functional starter substance (1-4) having carboxyl groups, and the molar ratio of the alkylene oxide (3) to the cyclic anhydride (2) is from 1.5:1 to 8.0:1, preferably from 1.8:1 to 5.0:1.

In a further embodiment of the process of the invention, the H-functional starter substance (1) is added to the reactor continuously.

In a further embodiment of the process of the invention, the cyclic anhydride (2) is added to the reactor continuously or stepwise.

In a further embodiment of the process of the invention, the cyclic alkylene oxide (3) is added to the reactor continuously or stepwise.

In a further embodiment of the process of the invention, the catalyst (4) is added to the reactor continuously or stepwise.

In a further embodiment of the process of the invention, in step i), the reactor is initially charged with the H-functional starter substance (1), and the cyclic anhydride (2) is added to the reactor stepwise or continuously.

In a further alternative embodiment of the process of the invention, in step i), the reactor is initially charged with the cyclic anhydride (2), and the H-functional starter substance (1) is added to the reactor stepwise or continuously.

In a further alternative embodiment of the process of the invention, the polyester polyol is withdrawn from the reactor continuously or stepwise, preferably continuously.

The present invention further provides an etheresterol, preferably a polyetheresterol, obtainable by the stipulated process of the invention.

In one embodiment, the etheresterol of the invention, preferably the polyetheresterol, has a viscosity of 1 mPas to 100 000 mPas, preferably of 500 mPas to 20 000 mPas, where the viscosity has been determined by means of the method disclosed in the experimental section.

In one embodiment, the etheresterol of the invention, preferably a polyetheresterol, has a number-average molecular weight of 18 g/mol to 10 000 g/mol, preferably of 100 g/mol to 3000 g/mol, the number-average molecular weight being determined by means of gel permeation chromatography (GPC) as disclosed in the experimental section.

The present invention further provides a process for preparing a polyurethane by reaction of the etheresterol of the invention, preferably a polyetheresterol, with a polyisocyanate.

The polyisocyanate may be an aliphatic or aromatic polyisocyanate. Examples include butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate (NDI), diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and alkyl 2,6-diisocyanatohexanoates (lysine diisocyanates) having C1 to C6 alkyl groups. Preference is given here to an isocyanate from the diphenylmethane diisocyanate series.

In addition to the abovementioned polyisocyanates, it is also possible to use proportions of modified diisocyanates having uretdione, isocyanurate, urethane, carbodiimide, uretonimine, allophanate, biuret, amide, iminooxadiazinedione and/or oxadiazinetrione structure, and also unmodified polyisocyanate having more than 2 NCO groups per molecule, for example 4-isocyanatomethyloctane 1,8-diisocyanate (nonane triisocyanate) or triphenylmethane 4,4′, 4″-triisocyanate.

### EXAMPLES

The present invention is more particularly elucidated with reference to the figures and examples which follow but without being limited thereto.

### Starting Materials Used

### H-functional Starter Substance (1): “Starter (1)”

| | |
|---|---|
| diethylene glycol (DEG) | (purity 99%, Sigma-Aldrich) |
| PEG-200 (PEG) | (Sigma-Aldrich) |

### Cyclic Anhydride (2): “CA (2)”

| | |
|---|---|
| succinic anhydride (SA) | (purity 99%, ABCR) |
| methylsuccinic anhydride (MeSA) | (purity 98%, Sigma Aldrich) |

### Alkylene Oxide (3): “AO (3)”

| | |
|---|---|
| ethylene oxide | EO (3.0 Gerling Holz): |

Catalysts: “Cat (4)”

| | |
|---|---|
| benzyldimethylamine (BDA) | (purity ≥99%, Sigma Aldrich) |
| diazabicyclo[2.2.2]octane (DABCO) | (purity ≥99%, Sigma Aldrich) |
| dibutyltin laurate (DBTL) | (purity 95%, Sigma Aldrich) |
| lead 2-ethylhexanoate (PbEH) | (40.5-42.5% Pb, abcr) |

### Materials for Foaming Experiments:

| | |
|---|---|
| Stepanpol PS 2352 | Stepanpol PS2352, aromatic polyester polyol |
| | from Stepan having an OH number of 240 mg |
| | KOH/g |
| Tegostab B 8421 | Tegostab B8421, foam stabilizer from Evonik |
| Levagard PP | TCPP, halogenated flame retardant from Lanxess |
| Desmorapid 726B | cyclohexyldimethylamine 99% Sigma-Aldrich |
| Desmorapid 1792 | Desmorapid 1792, catalyst with 25% by weight |
| | of potassium acetate from Covestro Deutschland |
| | AG |
| 44V20L | Desmodur 44V20L from Covestro Deutschland |
| | AG, polymeric isocyanate having an NCO |
| | content of 30.5% to 32.5% by weight and a |
| | viscosity of 200 mPa * s |
| c/i-pentane | mixture of cyclo- and isopentane (30:70), |
| | blowing agent |

### Description of the Methods:

OH number: OH number was determined by the method of DIN 53240-1.

COOH number: Acid number was determined according to DIN EN ISO 2114.

Viscosity: MCR 51 rheometer from Anton Paar in accordance with DIN 53019-1 using a CP 50-1 measuring cone, diameter 50 mm, angle 1° at shear rates of 25, 100, 200 and 500 s⁻¹. The inventive and noninventive polyols show viscosity values that are independent of the shear rate.

Index: This refers to the product of multiplying 100 by the molar ratio of NCO groups to NCO-reactive groups in a formulation.

Apparent density: Apparent density was determined to DIN EN ISO 845 (Oct. 2009).

Open-cell content: The open-cell content of the rigid PUR/PIR foams was measured with an Accupyk-1330 instrument on test specimens having dimensions of 5 cm×3 cm×3 cm according to DIN EN ISO 4590 (Aug. 2003).

Fire properties: The flame spread of the rigid PUR/PIR foams was measured by edge flaming on a sample of size 18 cm×9 cm×2 cm with a small burner test in accordance with DIN 4102-1. The fire class was determined by 2 individual measurements of the flame height. For attainment of the B2 fire class, the 2 individual values need to be below 15 cm. Flame heights above 15 cm result in the B3 fire class.

Gel permeation chromatography (GPC): Measurements were performed on an Agilent 1200 Series (G1311A Bin Pump, G1313A ALS, G1362A RID), detection by RID; eluent: tetrahydrofuran (GPC grade), flow rate 1.0 ml/min at 40° C. column temperature; column combination: 2×PSS SDV precolumn 100 Å (5 μm), 2×PSS SDV 1000 Å (5 μm). Calibration was effected using ReadyCal Kit Poly(styrene) low in the range of Mp=266−66 000 Da from “PSS Polymer Standards Service”. The measurement recording and evaluation software used was the “PSS WinGPC Unity” software package. The polydispersity index from weighted (Mw) and number-average (Mn) molecular weight from the gel permeation chromatography is defined as Mw/Mn.

### Example 1: EO/SA/MeSA-based Polyetherester Polyol

A 2.0 L steel reactor is initially charged with a mixture of diethylene glycol (105 g, 0.99 mol, 0.79 eq.), PEG-200 (52.7 g, 0.26 mol, 0.21 eq.), succinic anhydride (176 g, 1.76 mol, 1.41 eq.), methylsuccinic anhydride (176 g, 1.54 mol, 1.23 eq.) and the catalyst (benzyldimethylamine, 0.706 g, 1000 ppm). The reactor is sealed tight and inertized with N₂ (3×25 bar N₂→1-2 bar N₂). The reactor is heated to 125° C. under an N₂ atmosphere and then stirred at 1200 rpm for 60 min. The N₂ pressure is adjusted to 45 bar, and ethylene oxide (196 g, 4.44 mol, 3.55 eq.) is metered in at 125° C. for 90 min. The reaction is stirred at 125° C. for a further 150 min. The reactor is cooled down, vented and purged with N₂. Volatile components are removed under reduced pressure.

### Comparative Example 2: EO/SA-based Polyetherester Polyol

A 2.0 L steel reactor is initially charged with a mixture of diethylene glycol (100 g, 0.94 mol, 0.79 eq.), PEG-200 (50 g, 0.25 mol, 0.21 eq.), succinic anhydride (328 g, 3.27 mol, 3.00 eq.) and catalyst (benzyldimethylamine, 1.00 g, 1500 ppm). The reactor is sealed tight and inertized with N₂ (3×25 bar N₂→1-2 bar N₂). The reactor is heated to 125° C. under an N₂ atmosphere. It is subsequently stirred at 1200 rpm at 125° C. for 60 min. The N₂ pressure is adjusted to 45 bar, and ethylene oxide (191 g, 4.34 mol, 3.64 eq.) is metered in at 125° C. for 90 min. The reaction is stirred at 125° C. for a further 150 min. The reactor is cooled down, vented and purged with N₂. Volatile components are removed under reduced pressure.

### Example 3: EO/SA/MeSA-based Polyetherester Polyol

A 2.0 L steel reactor is initially charged with a mixture of water (20.1 g, 1.12 mol, 1.00 eq.), succinic anhydride (201 g, 2.01 mol, 1.79 eq.), methylsuccinic anhydride (201 g, 1.76 mol, 1.57 eq.) and the catalyst (benzyldimethylamine, 0.685 g, 1000 ppm). The reactor is sealed tight and inertized with N₂ (3×25 bar N₂→1-2 bar N₂). The reactor is heated to 125° C. under an N₂ atmosphere. It is subsequently stirred at 1200 rpm at 125° C. for 60 min. The N₂ pressure is adjusted to 45 bar, and ethylene oxide (264 g, 5.99 mol, 5.35 eq.) is metered in at 125° C. for 90 min. The reaction is stirred at 125° C. for a further 150 min. The reactor is cooled down, vented and purged with N₂. Volatile components are removed under reduced pressure.

### Comparative Example 4: EO/SA-based Polyetherester Polyol

A 2.0 L steel reactor is initially charged with a mixture of water (20.1 g, 1.12 mol, 1.00 eq.), succinic anhydride (402 g, 4.02 mol, 3.58 eq.) and the catalyst (benzyldimethylamine, 0.685 g, 1000 ppm). The reactor is sealed tight and inertized with N₂ (3×25 bar N₂→1-2 bar N₂). The reactor is heated to 125° C. under an N₂ atmosphere. It is subsequently stirred at 1200 rpm at 125° C. for 60 min. The N₂ pressure is adjusted to 45 bar, and ethylene oxide (264 g, 5.99 mol, 5.35 eq.) is metered in at 125° C. for 90 min. The reaction is stirred at 125° C. for a further 150 min. The reactor is cooled down, vented and purged with N₂. Volatile components are removed under reduced pressure.

### Example 5: EO/MeSA-based Polyetherester Polyol

A 300 mL steel reactor is initially charged with a mixture of ethylene glycol (16.0 g, 0.258 mol, 1.00 eq.) and methylsuccinic anhydride (75.3 g, 0.66 mol, 2.56 eq.), and the catalyst (DABCO, 0.132 g, 1000 ppm). The reactor is sealed tight and inertized with N₂ (3×25 bar N₂→1-2 bar N₂). The reactor is heated to 125° C. under an N₂ atmosphere. It is subsequently stirred at 500 rpm at 125° C. for 60 min. The N₂ pressure is adjusted to 45 bar, and ethylene oxide (40.4 g, 0.92 mol, 3.57 eq.) is metered in at 125° C. for 120 min. The reaction is stirred at 125° C. for a further 120 min. The reactor is cooled down, vented and purged with N₂. Volatile components are removed under reduced pressure.

### Example 6: EO/SA/MeSA-based Polyetherester Polyol

A 300 mL steel reactor is initially charged with a mixture of ethylene glycol (16.0 g, 0.258 mol, 1.00 eq.), succinic anhydride (49.1 g, 0.49 mol, 1.90 eq.) and methylsuccinic anhydride (24.6 g, 0.216 mol, 0.84 eq.), and the catalyst (DABCO, 0.132 g, 1000 ppm). The reactor is sealed tight and inertized with N₂ (3×25 bar N₂→1-2 bar N₂). The reactor is heated to 125° C. under an N₂ atmosphere. It is subsequently stirred at 500 rpm at 125° C. for 60 min. The N₂ pressure is adjusted to 45 bar, and ethylene oxide (42.4 g, 0.96 mol, 3.73 eq.) is metered in at 125° C. for 120 min. The reaction is stirred at 125° C. for a further 120 min. The reactor is cooled down, vented and purged with N₂. Volatile components are removed under reduced pressure.

### Comparative Example 7: EO/MeSA-based Polyetherester Polyol

A 300 mL steel reactor is initially charged with a mixture of ethylene glycol (16.0 g, 0.258 mol, 1.00 eq.), methylsuccinic anhydride (75.3 g, 0.66 mol, 2.56 eq.), and the catalyst (dibutyltin laurate (DBTL), 0.132 g, 1000 ppm). The reactor is sealed tight and inertized with N₂ (3×25 bar N₂→1-2 bar N₂). The reactor is heated to 125° C. under an N₂ atmosphere. It is subsequently stirred at 500 rpm at 125° C. for 60 min. The N₂ pressure is adjusted to 45 bar, and ethylene oxide (40.4 g, 0.918 mol, 3.56 eq.) is metered in at 125° C. for 120 min. The reaction is stirred at 125° C. for a further 120 min. The reactor is cooled down, vented and purged with N₂. Volatile components are removed under reduced pressure.

### Comparative Example 8: EO/MeSA-based Polyetherester Polyol

A 300 mL steel reactor is initially charged with a mixture of ethylene glycol (16.0 g, 0.258 mol, 1.00 eq.), methylsuccinic anhydride (75.3 g, 0.660 mol, 2.56 eq.), and the catalyst (lead 2-ethylhexanoate (PbEH), 0.132 g, 1000 ppm). The reactor is sealed tight and inertized with N₂ (3×25 bar N₂→1-2 bar N₂). The reactor is heated to 125° C. under an N₂ atmosphere. It is subsequently stirred at 500 rpm at 125° C. for 60 min. The N₂ pressure is adjusted to 45 bar, and ethylene oxide (40.4 g, 0.918 mol, 3.56 eq.) is metered in at 125° C. for 120 min. The reaction is stirred at 125° C. for a further 120 min. The reactor is cooled down, vented and purged with N_{2.} Volatile components are removed under reduced pressure.

### Foaming Experiments

Based on the polyol components, rigid PUR/PIR foams were produced in the laboratory by mixing 0.3 dm³ of a reaction mixture in a paper cup. To this end, the respective polyol component, the flame retardant, the foam stabilizer, catalysts and c/i-pentane (30:70) as blowing agent were added and the mixture was stirred briefly. The mixture obtained was mixed with the isocyanate and the reaction mixture was poured into a paper mold (2×2×1.4 dm) and reacted therein. The exact formulations of the individual experiments and the results of the physical measurements on the samples obtained are reproduced in table 2.

TABLE 1
Comparison of experiments 1 to 8

| | Starter (1) | CA (2) | CA (2-1) | AO (3) | Cat (4) | OH#^{[a]} | COOH# | Viscosity^{[b]} | Mₙ (Ð)^{[c]} | | Y |
|---|---|---|---|---|---|---|---|---|---|---|---|
| Experiment | [% by wt] | [% by wt.] | [% by wt.] | [% by wt.] | [ppm] | [mg/g] | [mg/g] | [mPas] | [g/mol (−)] | D | [%] |
| 1 | DEG: 15.0 | SA: 24.5 | MeSA: 24.5 | EO 28.5 | BDA | 221 | 0.5 | 1870 | 750 | 1.55 | 96 |
| | PEG-200: 7.5 | | | | 1500 ppm | | | | | | |
| 2 (comp.) | DEG: 15.0 | SA: 49.0 | MeSA: 0.0 | EO 28.5 | BDA | 234 | 0.2 | solid | 820 | 1.52 | 96 |
| | PEG-200: 7.5 | | | | 1500 ppm | | | (Tₘ: 70° C., | | | |
| | | | | | | | | 34 J/g) | | | |
| 3 | H₂O: 2.9 | SA: 29.3 | MeSA: 29.3 | EO 38.5 | BDA | 201 | 0.9 | 3300 | 850 | 1.57 | 94 |
| | | | | | 1000 ppm | | | | | | |
| 4 (comp.) | H₂O: 2.9 | SA: 58.6 | MeSA: 0.0 | EO 38.5 | BDA | —^{[d]} | —^{[d]} | solid | —^{[d]} | — | — |
| | | | | | 1000 ppm | | | (n.d.) | | | |
| 5 | EG: 12.1 | SA: 0.0 | MeSA: 100 | EO 31.8 | DABCO | 248 | 1.2 | 2260 | 720 | 1.51 | 98 |
| | | | | | 1000 ppm | | | | | | |
| 6 | EG: 12.1 | SA: 66.7 | MeSA: 33.3 | EO 31.8 | DABCO | 257 | 1.7 | 2100 | 720 | 1.53 | 98 |
| | | | | | 1000 ppm | | | | | | |
| 7 (comp.) | EG: 12.1 | SA: 0.0 | MeSA: 100 | EO 31.8 | DBTL | 75 | 0 | 1902 | 650 | 1.21 | 86 |
| | | | | | 1000 ppm | | | | | | |
| 8 (comp.) | EG: 12.1 | SA: 0.0 | MeSA: 100 | EO 31.8 | PbEH | 112 | 0 | 1702 | 618 | 1.21− | 88 |
| | | | | | 1000 ppm | | | | | | |

^{[a]}sum total of measured OH# and COOH#;
^{[b]}viscosity ascertained using MCR 51 rheometer from Anton Paar in accordance with DIN 53019-1
^{[c]}ascertained via GPC analysis in THF at RT,
^{[d]}not measurable via the analysis methods defined.

TABLE 2
Composition and results of the foaming experiments

| Example | | 9 (comparative) | 10 | 11 |
|---|---|---|---|---|
| Index | | 323 | 341 | 339 |
| Stepanpol PS 2352 | [parts] | 77.6 | — | — |
| Example 1 | [parts] | — | 77.6 | — |
| Example 3 | [parts] | — | — | 77.6 |
| Levagard TCPP | [parts] | 15.5 | 15.5 | 15.5 |
| Tegostab B8421 | [parts] | 2.0 | 2.0 | 2.0 |
| Water | [parts] | 1.2 | 1.2 | 1.2 |
| Desmorapid 1792 | [parts] | 2.8 | 2.8 | 2.8 |
| Desmorapid 726B | [parts] | 0.9 | 0.9 | 0.9 |
| c/i-Pentane | [parts] | 18.8 | 18.8 | 18.8 |
| Desmodur 44V20L | [parts] | 220 | 220 | 220 |
| Cream time | [s] | 14 | 16 | 14 |
| Fiber time | [s] | 43 | 49 | 49 |
| Rise time | [s] | 68 | 73 | 73 |
| Tack-free time | [s] | 90 | 90 | 110 |
| Apparent density | [kg/m³] | 29.9 | 29.4 | 29.7 |
| Open-cell content | [%] | 9.6 | 9.6 | 11.2 |
| Flame height | [cm] | 16/15 | 13/13 | 13/13 |
| Fire class | — | B3 | B2 | B2 |

1. A process for preparing an etheresterol by reaction of an H-functional starter substance with a cyclic anhydride in the presence of a catalyst;
wherein the cyclic anhydride contains an alkylsuccinic anhydride of the following formula (I): 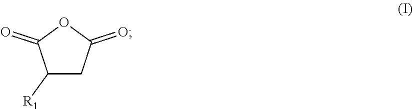
wherein R1 is methyl, ethyl, n-propyl, isopropyl, n-butyl, isobutyl, n-hexyl or isohexyl, and
wherein the catalyst is an amine, a double metal cyanide catalyst and/or a Brønsted acid.

2. The process as claimed in claim 1, wherein the reaction is effected in the presence of an alkylene oxide.

3. The process as claimed in claim 1, wherein the molar proportion of the alkylsuccinic anhydride is from 5 mol % to 100 mol %, based on the sum total of all cyclic anhydrides used.

4. The process as claimed in claim 1, wherein the H-functional starter substance is an OH-functional starter substance, an NH₂-functional starter substance, an NH-functional starter substance and/or a COOH-functional starter substance.

5. The process as claimed in claim 2, wherein the alkylene oxide is propylene oxide and/or ethylene oxide.

6. The process as claimed in claim 1, wherein the catalyst is an amine.

7. The process as claimed in claim 6, wherein the catalyst is a tertiary amine.

8. The process as claimed in claim 7, wherein the catalyst is a tertiary amine, and the tertiary amine is one or more compound selected from the group consisting of trimethylamine, triethylenediamine, triisopropylamine, tributylamine, tripentylamine, trihexylamine, triphenylamine, dimethylethylamine, N,N-dimethylcyclohexylamine, tetramethylenediamine, 1-methyl-4-dimethylaminoethylpiperazine, triethylamine, tripropylamine, tributylamine, dimethylbutylamine, N,N-dimethylbenzylamine, N,N-dimethylcyclohexylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, bis(dimethylaminoethyl) ether, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, 1,8-diazabicyclo[5.4.0]undec-7-ene, 1,5,7-triazabicyclo[4.4.0]dec-5-ene, 1,4-diazabicyclo[2.2.2]octane, imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole and N,N-dimethylaminopyridine, guanidine, 1,1,3,3-tetramethylguanidine, pyridine, 1-azanaphthalene (quinoline), N-methylpiperidine, N-methylmorpholine, N,N′-dimethylpiperazine and N,N-dimethylaniline.

9. The process as claimed in claim 2, the process comprising the following steps:
i) reacting the H-functional starter substance and the cyclic anhydride, to form a mixture, and
ii) adding a portion of the alkylene oxide to form the etheresterol.

10. The process as claimed in claim 1, wherein the molar ratio of the cyclic anhydride to the starter functionality of the H-functional starter substance is between 0.5:1 and 20:1.

11. The process as claimed in claim 2, wherein the H-functional starter substance is an OH-functional starter substance having terminal hydroxyl groups, and the molar ratio of the alkylene oxide to the cyclic anhydride is from 1.05:1 to 3.0:1.

12. An etheresterol prepared by the process as claimed in claim 1.

13. The etheresterol as claimed in claim 12, wherein the etheresterol has a viscosity of 1 mPas to 100 000 mPas.

14. The etheresterol as claimed in claim 12, wherein the etheresterol has a number-average molecular weight of 18 g/mol to 10 000 g/mol determined with gel permeation chromatography.

15. A process for preparing a polyurethane by reacting the etheresterol as claimed in claim 12 with a polyisocyanate.

16. The process as claimed in claim 1, wherein the etheresterol is a polyetheresterol.

17. The process as claimed in claim 1, wherein R1 is methyl.

18. The process as claimed in claim 3, wherein the molar proportion of the alkylsuccinic anhydride is from 25 mol % to 100 mol % based on the sum total of all cyclic anhydrides used.

19. The process as claimed in claim 4, wherein the H-functional starter substance is an OH-functional starter substance.

20. The process as claimed in claim 5, wherein the alkylene oxide is ethylene oxide.
